(19) United States
(12) Patent Application Publication
(10) Pub. No.: US 2020/0380947 A1
(43) Pub. Date: Dec. 3, 2020

(54) ACTIVE NOISE CONTROL WITH FEEDBACK COMPENSATION

(71) Applicant: Harman Becker Automotive Systems GmbH, Karlsbad (DE)

(72) Inventors: Nikos ZAFEIROPOULOS, Straubing (DE); Markus CHRISTOPH, Straubing (DE)

(73) Assignee: Harman Becker Automotive Systems GmbH, Karlsbad (DE)

(21) Appl. No.: 16/970,884

(22) PCT Filed: Feb. 19, 2018
(86) PCT No.: PCT/EP2018/054007

§ 371 Date: Aug. 18, 2020

(51) Int. Cl. G10K 11/178

(52) U.S. Cl. CPC G10K 11/17813; G10K 2210/3055; G10K 11/17885; G10K 11/17881

(57) ABSTRACT

Sound reduction includes producing an error signal representative of sound present in a target space, producing a reference signal corresponding to undesired sound present in the target space, and producing, based on the reference signal and the error signal a cancelling signal representative of the undesired sound present in the target space. Sound reduction further includes producing, based on the cancelling signal, sound to destructively interfere with the undesired sound present in the target space, producing sound based on an audio signal in the target space, and removing from the reference signal, based on the audio signal, a reference signal component representative of audio signal components transferred via a feedback path from the transducer to the reference sensor.

### BACKGROUND

### 1. Technical Field

The disclosure relates to active noise control, and more specifically to active noise control used with an audio system.

### 2. Related Art

Sound reduction that includes active noise control (ANC) may be used to generate sound waves that destructively interfere with undesired sound waves. The destructively interfering sound waves may be produced through a loudspeaker to combine with the undesired sound waves. ANC may be desired also in situations in which desired sound waves, such as music, may be produced as well. An audio or visual system may include various loudspeakers to generate the desired sound waves. These loudspeakers may be simultaneously used to produce the destructively interfering sound waves and the desired sound waves.

An ANC system may include an error microphone to detect residual sound proximate to an area targeted for destructive interference. Based on the detected residual sound an error signal is generated to adjust the destructively interfering sound waves. However, if the destructively interfering sound waves are generated by a loudspeaker that also generates the desired sound waves, the error microphone may also detect the desired sound waves, which may be included in the error signal. Thus, the ANC system may track sound waves not desired to be interfered with, such as the desired sound waves. Further, in ANC systems desired sound waves produced by the mutual loudspeaker may be fed back to reference sensors such as accelerometers and reference microphones, which pick up the undesired sound waves at their respective sources. This may lead to inaccurately generated destructive interference, and the active noise control system may generate sound waves that destructively interfere with the desired sound waves. Therefore, a need exists to reduce the interference between desired sound waves and undesired sound waves in an active noise control system.

### SUMMARY

An example sound reduction system includes an error sensor configured to produce an error signal representative of sound present in a target space, and a reference sensor configured to produce a reference signal corresponding to undesired sound present in the target space. The system further includes an active noise controller operatively coupled with the error sensor and the reference sensor, the active noise controller configured to produce, based on the reference signal and the error signal, a cancelling signal representative of the undesired sound present in the target space, and a transducer operatively coupled with the active noise controller and configured to produce, based on the cancelling signal, sound to destructively interfere with the undesired sound present in the target space, the transducer further configured to produce sound based on an audio signal. The active noise controller is further configured to remove from the reference signal, based on the audio signal, a reference signal component representative of audio signal components transferred via a feedback path from the transducer to the reference sensor.

An example sound reduction method includes producing an error signal representative of sound present in a target space, producing a reference signal corresponding to undesired sound present in the target space, and producing, based on the reference signal and the error signal, a cancelling signal representative of the undesired sound present in the target space. The method further includes producing, based on the cancelling signal, sound to destructively interfere with the undesired sound present in the target space, producing sound based on an audio signal in the target space, and removing from the reference signal, based on the audio signal, a reference signal component representative of audio signal components transferred via a feedback path from the transducer to the reference sensor.

Other systems, methods, features and advantages will be, or will become, apparent to one with skill in the art upon examination of the following detailed description and appended figures. It is intended that all such additional systems, methods, features and advantages be included within this description, be within the scope of the invention, and be protected by the following claims.

### BRIEF DESCRIPTION OF THE DRAWINGS

The system may be better understood with reference to the following drawings and description. The components in the figures (FIG) are not necessarily to scale, emphasis instead being placed upon illustrating the principles of the invention. Moreover, in the figures, like referenced numerals designate corresponding parts throughout the different views.

FIG. 1 is a schematic diagram illustrating an exemplary basic single-channel sound reduction system of the feedforward type with audio signal input.

FIG. 2 is a schematic diagram illustrating an exemplary single-channel sound reduction system with adaptive signal compensation for the reference signal and fix error signal compensation for the error signal.

FIG. 3 is a schematic diagram illustrating an exemplary basic multi-channel sound reduction system of the feedforward type with audio signal input.

FIG. 4 is a schematic diagram illustrating an exemplary multi-channel sound reduction system with adaptive signal compensation for the reference signal and fix signal compensation for the error signal.

FIG. 5 is a schematic diagram illustrating an exemplary multi-channel sound reduction system with adaptive signal compensation for the reference signal and adaptive error signal compensation for the error signal.

FIG. 6 is a schematic diagram illustrating an exemplary multi-channel sound reduction system with fix signal compensation for the reference signal and fix signal compensation for the error signal.

FIG. 7 is a top view of an example vehicle implementing a sound reduction system.

FIG. 8 is a flow chart illustrating an exemplary sound reduction method.

### DETAILED DESCRIPTION

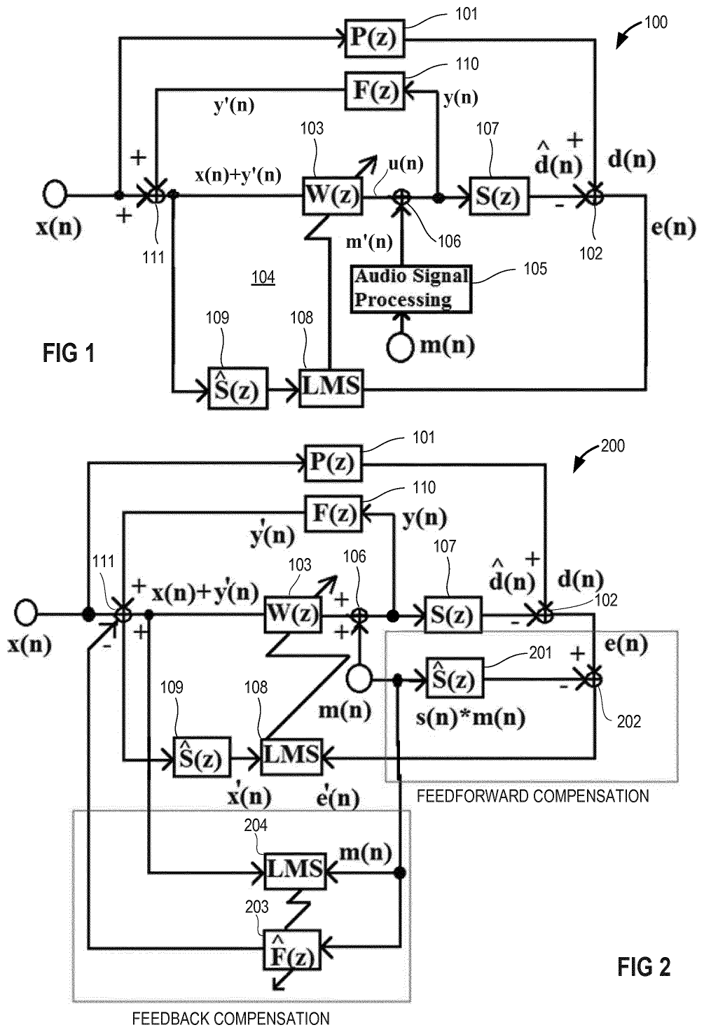

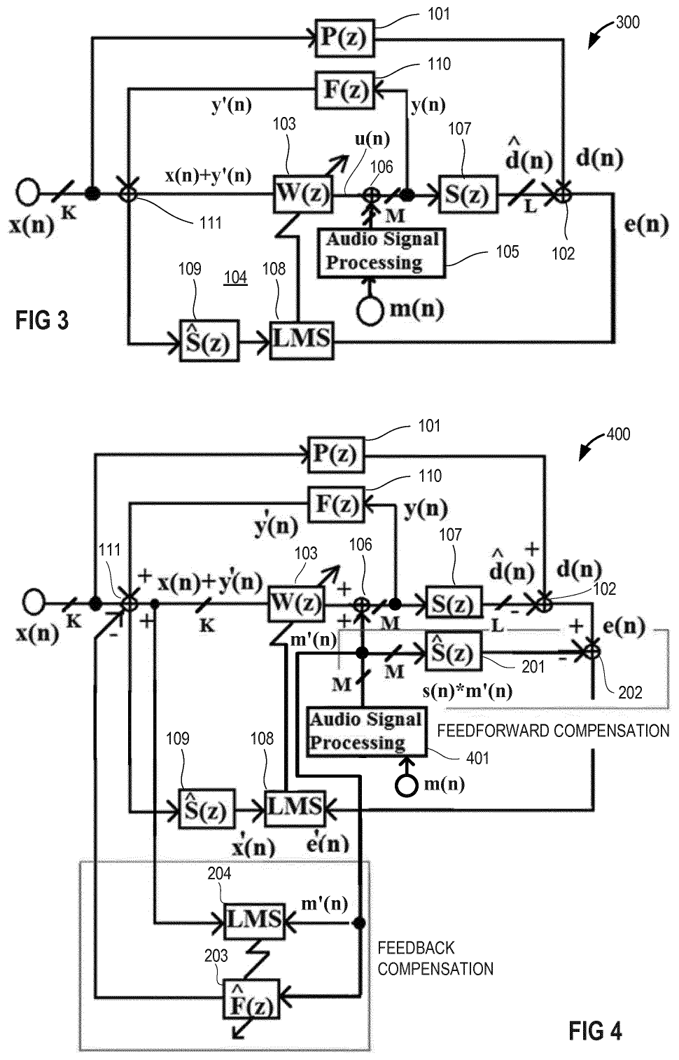

ANC systems may be based on, integrated in or combined with, for example, audio systems, e.g., vehicle audio systems, provided a high audio quality is maintained without any significant interference with ANC, i.e., without deterioration of the audio (music and/or speech) quality in the vehicle. For example, in a road noise cancellation system that shares at least some parts and units such as loudspeakers, amplifiers, microphones, processors etc. with the vehicle audio system, sound produced by the loudspeakers based on an audio signal, i.e., a desired signal, may be fed back to the reference sensors, e.g., accelerometers and/or microphones. The basic mechanism of vibrational and/or acoustic feedback between loudspeakers and reference sensors is described below with reference to FIGS. 1 and 3. Herein, undesired sound is any sound that is annoying to a listener such as all kinds of noise including vehicle engine sound, road noise etc., but can also be music or speech of others when, for example, the listener wants to make a telephone call. However, music or speech can be a desired sound if the listener wants to listen to it. Other types of desired sound may be warning signals or even vehicle engine sound when it serves as feedback information for a driver operating the vehicle. Therefore, undesired sound is sound that is to be cancelled and desired sound is sound that is not to be cancelled.

Referring to FIG. 1, an example single-channel feedforward ANC system 100 and an example physical environment are represented through a block diagram format. In one example, an undesired sound x(n) such as noise may traverse a physical path, referred to as acoustic primary path 101, from a source (not shown) of the undesired sound x(n) to a microphone 102 where it forms a microphone input signal component d(n). The microphone 102 is represented by a subtracting node that performs a subtraction operation in the example system shown in FIG. 1. The primary path 101 may have a z-domain transfer function P(z) with which the undesired sound x(n) is filtered to provide a filtered undesired sound represented by the microphone input signal component d(n). The undesired sound x(n) represents the undesired sound both physically and digitally, wherein a digital representation may be produced through use of an analog-to-digital (A/D) converter. The undesired sound x(n) may also be used as an input to an adaptive filter 103, which may be included in an anti-noise generator 104. The adaptive filter 103 may have a z-domain transfer function W(z) and may be a digital filter configured to be dynamically adapted to filter an input signal in order to produce a desired anti-noise signal u(n) as an output.

The anti-noise signal u(n) and a desired signal, e.g., an audio signal m(n) processed by an audio signal processor 105, i.e., a processed audio signal m′(n), may be combined to drive a loudspeaker 106. Processing the audio signal m(n) is optional and may include, for example, at least one of cross-over filtering, equalizing, limiting, loudness filtering, gain adjustment, delaying etc. Alternatively, no processing may be applied. The combination of the anti-noise signal u(n) and the processed audio signal m′(n) produces a sound wave output y(n) from the loudspeaker 106. In the example system shown in FIG. 1, the loudspeaker 106 is represented by a summing node that performs a summation operation on the anti-noise signal u(n) and the processed audio signal m′(n) and provides the loudspeaker output y(n). The loudspeaker output y(n) may be a sound wave that travels a physical path, referred to as acoustic secondary path 107, which extends from the loudspeaker 106 to the microphone 102. The secondary path 107 in the example system shown in FIG. 1 has a z-domain transfer function S(z). The loudspeaker output y(n) filtered with the transfer function S(z), i.e., input signal component \hat{d}(n), and the undesired sound x(n) filtered with the transfer function P(z), i.e., input signal component d(n), may be received by the microphone 102, the difference of which is the microphone output represented by an error signal e(n). In other examples, any number of loudspeaker and microphones may be present.

The output signal of the microphone 102, i.e., error signal e(n), is transmitted to a filter controller 108, which may be included in the anti-noise generator 104. The filter controller 108 may implement one of various possible adaptive control structures, such as least mean squares (LMS), recursive least mean squares (RLMS), normalized least mean squares (NLMS), or any other suitable algorithm. The filter controller 108 also receives as an input the undesired sound x(n) filtered by a filter 109. The filter 109 may have a z-domain transfer function Ŝ(z) and is configured to simulate, estimate or model the transfer function S(z). The filter controller 108 updates the adaptive filter 103 according to an update signal. Thus, the adaptive filter 103 receives the undesired noise x(n) and the update signal in order to more accurately cancel the undesired noise x(n) by providing the anti-noise signal y(n).

The loudspeaker output y(n) is undesirably fed back via a feedback path 110, which has a z-domain transfer function F(z), and interferes as a feedback sound y′(n) that corresponds to the anti-noise signal y(n) with the undesired sound x(n). In FIG. 1, the interference is represented by a summing node 111 which adds the feedback anti-noise signal y′(n) to the undesired sound x(n) so that the adaptive filter 103 receives as an input a signal x(n)+y′(n) that represents the input signal x(n) corrupted by the fed back anti-noise signal y′(n). The combination of an LMS algorithm (employed in the filter controller 108) and pre-filtering (with filter 109) establishes an FxLMS control scheme.

A component representative of the audio signal m(n) may be removed from the microphone input signal component \hat{d}(n), through processing of the error signal e(n). Referring now to FIG. 2, in an exemplary ANC system 200 that may be based on the ANC system 100 described above with regard to FIG. 1, the audio signal m(n) may be processed to reflect the traversal of the secondary path 107 by the sound wave of the (processed) audio signal m(n). This processing may be performed by estimating the transfer function S(z) of the secondary path 107 with an estimated secondary path filter 201, which applies a z-domain estimated secondary path transfer function Ŝ(z) to the audio signal m(n) traversing the estimated secondary path filter 201. The estimated secondary path filter 201 is configured to simulate or model the effect on the sound wave of the audio signal m(n) of traveling through the secondary path 107 and to generate an output signal s(n)*m(n). As can be seen from FIG. 2, the audio signal processor 105 has been omitted so that the audio signal m(n) is directly supplied to the loudspeaker 106. Similarly to the system shown in FIG. 1, the loudspeaker 106 generates the signal y(n), which is fed back through feedback path 110 to summing node 111 and where it arrives as the signal y′(n). The summing node 111 outputs the signal x(n)+y′(n), which is supplied to the adaptive filter 103 and to the filter 109. The filter 109 outputs the signal x′(n) which is transmitted to the filter controller 108.

The microphone input signal, which includes the microphone input signal components d(n) and \hat{d}(n) and which is represented by the error signal e(n), may be processed such that a component representative of the audio signal m(n) is removed as indicated by a subtracting node 202. This may occur by subtracting from the error signal e(n) at the subtracting node 202 the audio signal m(n) filtered by the estimated path filter 201 with the estimated transfer function Ŝ(z). Alternatively, any other mechanism, procedure or method may be employed to remove the S(z)-filtered audio signal m(n) from the error signal e(n). The output of the subtracting node 202 is a modified error signal e′(n), which may represent an audible sound remaining after any destructive interference between sound produced by the loudspeaker 106 based on the anti-noise signal y(n) and sound corresponding to the undesired noise x(n).

Further, the exemplary ANC system 200 may include an estimated feedback path filter 203 which receives the audio signal m(n), and filters the audio signal m(n) with a z-domain transfer function \hat{F}(z) to provide an \hat{F}(z)-filtered audio signal m(n) to the summation node 111 such that a component representative of the audio signal m(n), which is fed back via a feedback path 110 to the summing node 111, is removed as indicated by a negative sign at the summing node 111. This may occur by inverting the \hat{F}(z)-filtered audio signal at the summation node 111 and adding the inverted signal to the input signal x(n). Alternatively, the filtered audio signal could be subtracted or employ any other mechanism, procedure or method to remove the fed back signal. The estimated feedback path filter 203 is configured to simulate or model the effect on the sound wave of the audio signal m(n) of traveling through the feedback path 110. The audio signal m(n) is transmitted to a filter controller 204, which may implement various adaptive control schemes, such as least mean squares (LMS), recursive least mean squares (RLMS), normalized least mean squares (NLMS), or any other suitable control algorithm. The filter controller 204 also receives as an input the signal x(n)+y′(n), and updates the adaptive filter 203 via an update signal.

The basic structure of the single channel feedforward ANC system 100 described above in connection with FIG. 1 can also be applied to a multi-channel system 300 as depicted in FIG. 3. The exemplary multi-channel system 300 includes K reference input channels for K undesired signals x(n), M audio input channels for M audio signals m(n) or processed audio signals m′(n), and L noise cancelling channels for producing at the microphone 102 L microphone input signal components \hat{d}(n) which are representative of the noise cancelling sound y(n) transferred via the secondary paths 107. Further, the adaptive filters 103 receives the signals x(n)+y′(n), which are the sum of the undesired signal x(n) and the signal y′(n) which is representative of the fed back loudspeaker output y(n).

Similarly, the basic structure of the single channel ANC system 200 described above in connection with FIG. 2 can also be applied to a multi-channel system 400 as depicted in FIG. 4. The exemplary multi-channel system 400 includes K reference input channels for K undesired signals x(n), M audio input channels for M audio signals m(n), and L noise cancelling channels for producing at the microphone 102 L microphone input signal components \hat{d}(n) which are representative of the noise cancelling sound. Further, the M audio signals m(n) are processed with an audio signal processor 401 before they are supplied as processed audio signals m′(n) to the loudspeakers 106, estimated path filters 201, adaptive filter 203 and the filter controller 204.

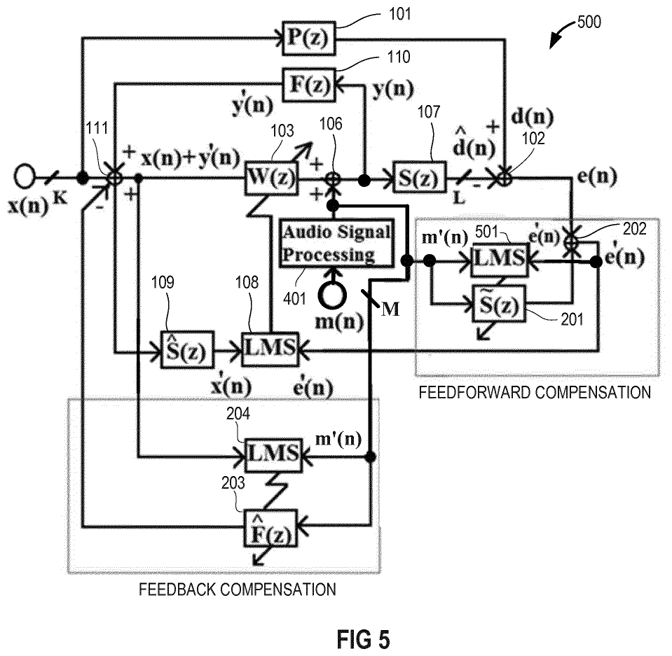

As depicted in FIG. 5, the system shown in FIG. 4 may be altered so that the filter 201 is an adaptive filter and receives the audio signal m(n) after it has been processed by the audio signal processor 401. The system shown in FIG. 5, referred to as system 500, further includes a filter controller 501 which receives the processed audio signal m′(n) and the modified error signal e′(n) and which controls the filter 201 based on the processed audio signal m′(n) and the modified error signal e′(n) according to one of various adaptive control schemes, such as least mean squares (LMS), recursive least mean squares (RLMS), normalized least mean squares (NLMS), or any other suitable control algorithm.

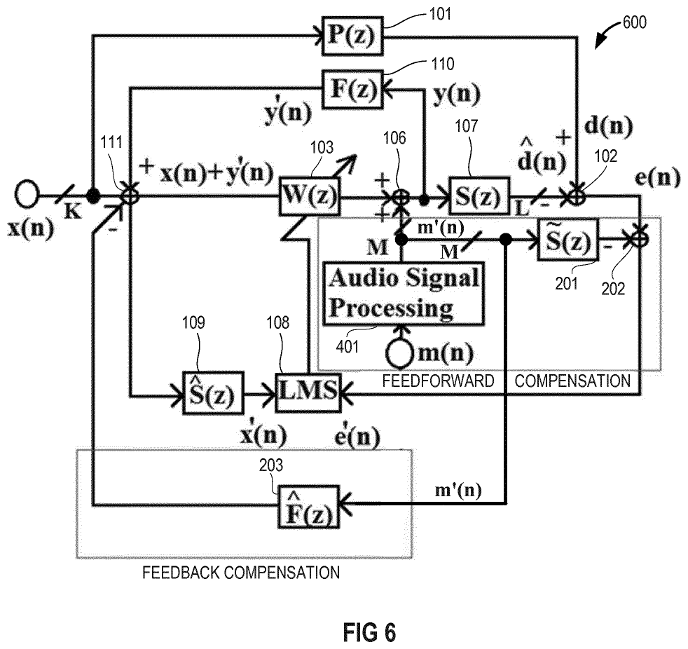

As depicted in FIG. 6, the system shown in FIG. 4 may be altered so that the estimated feedback path filter 203 is a fix filter whose transfer function \hat{F}(z) is predetermined.

The feedback compensation in the systems shown in FIGS. 2, 4 and 5 is based on an adaptive scheme that uses the audio signal m(n) or the processed audio signal m′(n) as a reference. Processing the audio signal m(n) may include, for example, at least one of cross-over filtering, equalizing, limiting, loudness filtering, gain adjustment, delaying etc. The audio signal m(n) may be provided by any appropriate audio source, such as, e.g., a vehicle head unit. When utilized in vehicles, e.g., cars, a multi-channel adaptive algorithm for feedback compensation is at least deployed to channels that show a strong mechanical (for vibration sensors as reference sensors) or acoustic (microphones as reference sensors) coupling between the secondary sources, e.g., the loudspeaker(s), and the reference sensors, e.g., accelerometers and/or reference microphones, that pick up the reference signal, i.e., the undesired input x(n). The feedback compensation described above may additionally be combined with any error signal compensation concepts but can, nevertheless, be implemented independently thereof.

The feedback compensation (applied to the reference signal) and/or the feedforward compensation (applied to the error signal) may or may not be adaptive. For example, the feedback path can be measured once and then stored for further processing (see FIG. 6) or repeatedly measured during processing (see FIGS. 2, 4 and 5). Similarly, the audio signal path, which is the secondary path, can be measured once and then stored for further processing (see FIGS. 2, 4 and 6) or repeatedly measured during processing (see FIG. 5). Adaptive or non-adaptive error signal compensation is configured to avoid undesired cancellation of audio signals, specifically of the spectral parts of the audio signals (e.g., lower frequency parts). Ideally, the target is to completely block the audio signals picked up by the error sensors and hence to avoid an unintended cancellation of audio signal parts by the ANC system, e.g., road noise cancellation (RNC) system. Naturally, an even greater capability to avoid such an unintended cancellation of parts of the audio signal can be achieved if both concepts, feedback compensation and error signal compensation, are combined as shown in FIGS. 2, 4, 5 and 6.

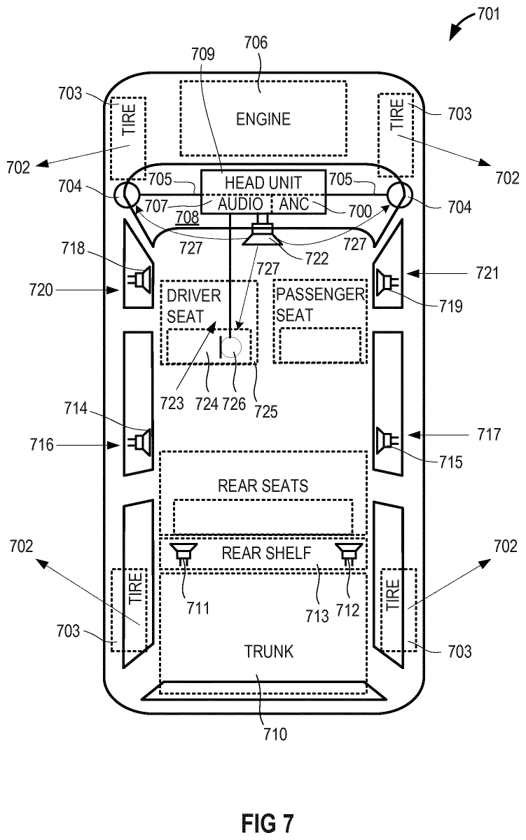

Referring to FIG. 7, an example ANC system 700 may be implemented in an example vehicle 701. In one example, the ANC system 700 may be configured to reduce or eliminate undesired sounds associated with the vehicle 701. For example, the undesired sound may be road noise 702 (represented in FIG. 7 as a dashed arrow) associated with, for example, tires 703. However, various undesired sounds may be targeted for reduction or elimination such as engine noise or any other undesired sound associated with the vehicle 701. The road noise 702 may be detected through at least one reference sensor. In one example, the at least one reference sensor may be two accelerometers 704, which may generate road noise signals 705 based on a current operating condition of the tires 703 and indicative of the level of the road noise 702. Other manners of sound detection may be implemented, such as microphones, non acoustic sensors, or any other sensors suitable for detecting audible sounds associated with the vehicle 701, e.g., the tires 703 or an engine 706. The road noise signals 705 are transmitted as reference signals to the ANC system 700.

The vehicle 701 may contain various audio/video components. In FIG. 7, the vehicle 701 is shown as including an audio system 707, which may include various devices for providing audio/visual information, such as an AM/FM radio, CD/DVD player, mobile phone, navigation system, MP3 player, or personal music player interface. The audio system 707 may be embedded in the dash board 708, e.g., in a head unit 709 disposed therein. The audio system 707 may also be configured for mono, stereo, 5-channel, and 7-channel operation, or any other audio output configuration. The audio system 707 may include a plurality of loudspeakers in the vehicle 701. The audio system 707 may also include other components, such as one or more amplifiers (not shown), which may be disposed at various locations within the vehicle 701 such as in a trunk 710.

In one example, the vehicle 701 may include a plurality of loudspeakers, such as a left rear loudspeaker 711 and a right rear loudspeaker 712, which may be positioned on or within a rear shelf 713. The vehicle 701 may also include a left side loudspeaker 714 and a right side loudspeaker 715, each mounted within a vehicle rear door 716 and 717, respectively. The vehicle 701 may also include a left front loudspeaker 718 and a right front loudspeaker 719, each mounted within a vehicle front door 720, 721, respectively. The vehicle 701 may also include a center loudspeaker 722 positioned within the dashboard 708. In other examples, other configurations of the audio system 707 in the vehicle 701 are possible.

In one example, the center loudspeaker 722 may be used to transmit anti-noise to reduce road noise 702 that may be heard in a target space 723. In one example, the target space 723 may be an area proximate to a driver's ears, which may be proximate to a head rest 724 of a driver seat 725. In FIG. 7, an error sensor such as a microphone 726 may be disposed in, at or adjacent to the head rest 724. The microphone 726 may be connected to the ANC system 700 in a manner similar to that described in regard to FIGS. 2, 4, 5 and 6. In FIG. 7, the ANC system 700 and audio system 707 are connected to the center loudspeaker 722, so that signals generated by the audio system 707 and the ANC system 700 may be combined to drive center loudspeaker 722 and produce a loudspeaker output 727 (represented as dashed arrows). This loudspeaker output 727 may be produced as a sound wave so that the anti-noise destructively interferes with the road noise 702 in the target space 723. One or more other loudspeakers in the vehicle 701 may be selected to produce a sound wave that includes cancelling sound, i.e., anti-noise. Furthermore, the microphone 726 may be placed at various positions throughout the vehicle in one or more desired target spaces.

As can be seen from FIG. 7, the ANC system is intended to produce sound that destructively interferes with undesired sound. The undesired sound may be, e.g., road noise or engine noise generated by a vehicle traveling down a road. At the same time it is intended to produce other sound that is considered desirable by a user sitting in the vehicle such as, for example, a song or speech on a radio for the user's enjoyment. Thus, the ANC system generates (e.g., in connection with an audio system that generates the desired sound) sound to destructively interfere with the undesired road noise. The desired audio signal is received by one or more loudspeakers such as loudspeaker 722 to produce the desired sound in the target space. The desired sound, however, may be transmitted to the reference sensor, e.g., accelerometer 704 and/or to the error sensor, e.g., microphone 726, and generate signal components in the reference signal and/or the error signal that refer back to the audio signal and which are not to be cancelled.

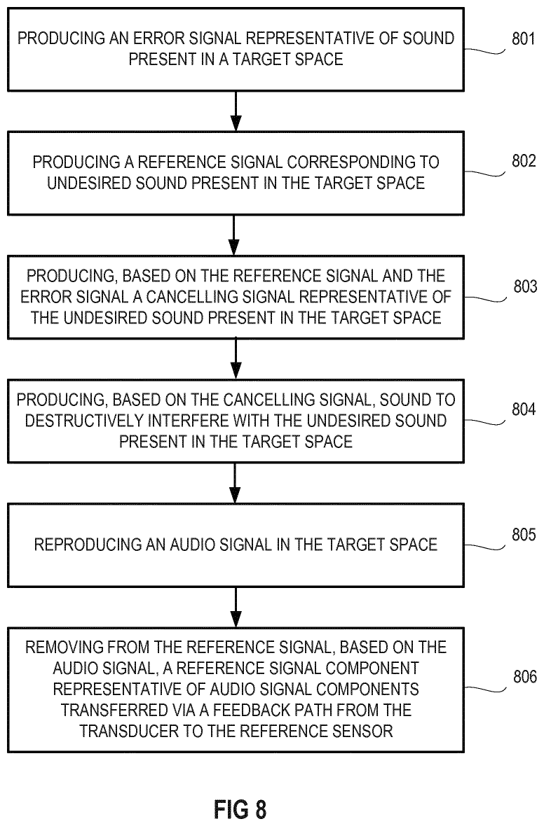

Referring to FIG. 8, an exemplary sound reduction method includes producing an error signal representative of sound present in a target space (801); producing a reference signal corresponding to undesired sound present in the target space (802); and producing, based on the reference signal and the error signal, a cancelling signal representative of the undesired sound present in the target space (803). The method further includes producing, based on the cancelling signal, sound to destructively interfere with the undesired sound present in the target space (804); reproducing an audio signal in the target space (805); and removing from the reference signal, based on the audio signal, a reference signal component representative of audio signal components transferred via a feedback path from the transducer to the reference sensor (806).

The embodiments of the present disclosure generally provide for a plurality of circuits, electrical devices, and/or at least one controller. All references to the circuits, the at least one controller, and to other electrical devices, as well as the functionality provided by each of these, are not intended to be limited to encompass only what is illustrated and described herein. While particular labels may be assigned to the various circuit(s), controller(s) and other electrical devices disclosed, such labels are not intended to limit the scope of operation for the various circuit(s), controller(s) and other electrical devices. Such circuit(s), controller(s) and other electrical devices may be combined with each other and/or separated in any manner based on the particular type of electrical implementation that is desired.

It is recognized that any computer, processor and controller as disclosed herein may include any number of microprocessors, integrated circuits, memory devices (e.g., FLASH, random access memory (RAM), read only memory (ROM), electrically programmable read only memory (EPROM), electrically erasable programmable read only memory (EEPROM), or other suitable variants thereof) and software which co-act with one another to perform operation(s) disclosed herein. In addition, any controller as disclosed utilizes any one or more microprocessors to execute a computer-program that is embodied in a non-transitory computer readable medium that is programmed to perform any number of the functions as disclosed. Further, any controller as provided herein includes a housing and the various number of microprocessors, integrated circuits, and memory devices (e.g., FLASH, random access memory (RAM), read only memory (ROM), electrically programmable read only memory (EPROM), electrically erasable and programmable read only memory (EEPROM)) positioned within the housing. The computer(s), processor(s) and controller(s) as disclosed also include hardware based inputs and outputs for receiving and transmitting data, respectively from and to other hardware based devices as discussed herein.

The description of embodiments has been presented for purposes of illustration and description. Suitable modifications and variations to the embodiments may be performed in light of the above description or may be acquired from practicing the methods. For example, unless otherwise noted, one or more of the described methods may be performed by a suitable device and/or combination of devices. The described methods and associated actions may also be performed in various orders in addition to the order described in this application, in parallel, and/or simultaneously. The described systems are exemplary in nature, and may include additional elements and/or omit elements.

As used in this application, an element or step recited in the singular and proceeded with the word “a” or “an” should be understood as not excluding plural of said elements or steps, unless such exclusion is stated. Furthermore, references to “one embodiment” or “one example” of the present disclosure are not intended to be interpreted as excluding the existence of additional embodiments that also incorporate the recited features. The terms “first,” “second,” and “third,” etc. are used merely as labels, and are not intended to impose numerical requirements or a particular positional order on their objects.

While various embodiments of the invention have been described, it will be apparent to those of ordinary skilled in the art that many more embodiments and implementations are possible within the scope of the invention. In particular, the skilled person will recognize the interchangeability of various features from different embodiments. Although these techniques and systems have been disclosed in the context of certain embodiments and examples, it will be understood that these techniques and systems may be extended beyond the specifically disclosed embodiments to other embodiments and/or uses and obvious modifications thereof.

1. A sound reduction system comprising:
an error sensor configured to produce an error signal representative of sound present in a target space;
a reference sensor configured to produce a reference signal corresponding to undesired sound present in the target space;
an active noise controller operatively coupled with the error sensor and the reference sensor, the active noise controller configured to produce, based on the reference signal and the error signal, a cancelling signal representative of the undesired sound present in the target space; and
a transducer operatively coupled with the active noise controller and configured to produce, based on the cancelling signal, sound to destructively interfere with the undesired sound present in the target space, the transducer being further configured to produce sound based on an audio signal; wherein
the active noise controller is further configured to remove from the reference signal, based on the audio signal, a reference signal component representative of audio signal components transferred via a feedback path from the transducer to the reference sensor.

2. The system of claim 1, wherein the active noise controller is further configured to remove from the error signal, based on the audio signal, an error signal component representative of audio signal components transferred via a secondary path from the transducer to the error sensor.

3. The system of claim 1, wherein the active noise controller comprises a feedback path modeling filter that is supplied with the audio signal, and wherein the feedback path modeling filter provides the reference signal component to be removed, and includes a transfer function that is an estimate of a transfer function of the feedback path.

4. The system of claim 3, wherein the feedback path modeling filter is configured to adapt a transfer function thereof to the transfer function of the feedback path based on the audio signal and the reference signal with removed reference signal component.

5. The system of claim 4, wherein the feedback path modeling filter is further configured to adapt the transfer function thereof according to a least mean square processing scheme.

6. The system of claim 2, wherein the active noise controller comprises a secondary path modeling filter that is supplied with the audio signal, and wherein the second path modeling filter provides the error signal component to be removed, and includes a transfer function that is an estimate of a transfer function of the secondary path.

7. The system of claim 6, wherein the secondary path modeling filter is configured to adapt a transfer function thereof to the transfer function of the secondary path based on the audio signal and the error signal with removed error signal component.

8. The system of claim 7, wherein the secondary path modeling filter is further configured to adapt the transfer function thereof according to a least mean square processing scheme.

9. The system of claim 6, further comprising an audio preprocessor configured to preprocess the audio signal before the audio signal is supplied to at least one of the transducer and the secondary path modeling filter.

10. The system of claim 1, wherein the active noise controller is configured to operate according to a least mean square processing scheme.

11. The system of claim 10, wherein the least mean square processing scheme is a filtered-x least mean square processing scheme.

12. A sound reduction method comprising:
producing an error signal representative of sound present in a target space;
producing a reference signal corresponding to undesired sound present in the target space;
producing, based on the reference signal and the error signal, a cancelling signal representative of the undesired sound present in the target space;
producing, based on the cancelling signal, sound to destructively interfere with the undesired sound present in the target space;
producing sound in the target space based on an audio signal; and
removing from the reference signal, based on the audio signal, a reference signal component representative of audio signal components transferred via a feedback path from a transducer to a reference sensor.

13. The method of claim 12, further comprising removing from the error signal, based on the audio signal, an error signal component representative of audio signal components transferred via a secondary path from a transducer to an error sensor.

14. The method of claim 12, further comprising providing a feedback path modeling that is based on the audio signal, and providing the reference signal component to be removed based on the audio signal and an estimate of a transfer function of a feedback path from the transducer to the reference sensor.

15. The method of claim 14, wherein providing the feedback path modeling comprises adapting the transfer function of the feedback path modeling to the transfer function of the feedback path based on the audio signal and the reference signal with the removed reference signal component.

16. The method of claim 15, wherein adapting the transfer function of the feedback path modeling is performed according to a least mean square processing scheme.

17. The method of claim 13, further comprising secondary path modeling based on the audio signal, and providing the error signal component to be removed based on the audio signal and an estimate of a transfer function of a secondary path from the transducer to the error sensor.

18. The method of claim 17, wherein the secondary path modeling comprises adapting a transfer function of the secondary path modeling to the transfer function of the secondary path based on the audio signal and the error signal with the removed error signal component.

19. The method of claim 18, wherein adapting the transfer function of the secondary path modeling is performed according to a least mean square processing scheme.

20. The method of claim 17, further comprising preprocessing the audio signal before the sound is produced based on the audio signal and the audio signal which is subject to a secondary path modeling.

21. The method of claim 12, wherein producing the cancelling signal is based on a least mean square processing scheme.

22. The method of claim 21, wherein the least mean square processing scheme is a filtered-x least mean square processing scheme.

23. (canceled)

24. A computer-program product embodied in a non-transitory computer read-able medium that is programmed for providing a sound reduction, the computer-program product comprising instructions for:
providing an error signal representative of sound present in a target space;
providing a reference signal corresponding to undesired sound present in the target space;
providing, based on the reference signal and the error signal, a cancelling signal representative of the undesired sound present in the target space;
providing, based on the cancelling signal, sound to destructively interfere with the undesired sound present in the target space;
providing sound in the target space based on an audio signal; and
removing from the reference signal, based on the audio signal, a reference signal component representative of audio signal components transferred via a feedback path from a transducer to a reference sensor.
